(19) United States
(12) Patent Application Publication
(10) Pub. No.: US 2009/0288344 A1
(43) Pub. Date: Nov. 26, 2009

(54) Cable Brake Bracket

(75) Inventors: John Schram, Archbold, OH (US); Gerald H. Williams, West Branch, MI (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: NAPOLEON SPRINGWORKS, INC.

(21) Appl. No.: 12/244,639

(22) Filed: Oct. 2, 2008

Related U.S. Application Data
(60) Provisional application No. 61/055,679, filed on May 23, 2008.

(51) Int. Cl. E05F 11/04; E06B 3/00

(52) U.S. Cl. 49/199; 49/507

(57) ABSTRACT

Brackets for interrupting the opening of a multi-panel garage door and methods for their use, the brackets including a first plate having an inner face and an outer face, a pin located on the outer face of the first plate, and a protrusion associated with the first plate, the protrusion and pin defining a gap capable of accepting a garage door opening cable.

This application claims priority to U.S. Provisional Patent Application Ser. No. 61/055,679, filed May 23, 2008, the entirety of which is incorporated herein by reference.

### BACKGROUND OF THE INVENTION

(1) Field of the Invention

This invention concerns a cable brake bracket that is attached to an overhead garage door that is opened and closed with a cable or chain. The cable brake bracket is associated with the cable or chain in a manner that allows the cable brake bracket to gently brake and interrupt the opening of the overhead garage door using the counter balance spring to soften the brake action

(2) Description of the Art

Overhead garage doors that are opened with cables and chains are commonly used in commercial applications. One problem encountered with such garage doors is that they can be opened too far causing a garage door to ride off its rails.

There are several known methods for interrupting the opening of cable driven multipanel overhead garage doors. In one method, a leaf spring is attached to the end or top of a garage door track. The leaf spring contacts the door when the garage door reaches its desired opening height. Another device used in the art for interrupting the opening of a multi-panel garage door is a pusher spring positioned to engage the top of the multi-panel garage door when the door reaches its desired opening height. Both of these prior art springs dampen the opening of the door and prevent the door from opening further than intended.

The spring brakes discussed above have several disadvantages. One disadvantage is that they are difficult to install and repair as they are typically installed in difficult to access locations. Moreover, the spring devices are expensive and prone to failure. There is a need, therefore, for an inexpensive, easily installed multi-panel overhead door brake that dampens and interrupts the movement of a cable driven overhead door when it reaches its desired opening height.

### SUMMARY OF THE INVENTION

One aspect of this invention is a bracket comprising: a first plate having an inner face and an outer face; a pin located on the outer face of the first plate; and a protrusion associated with the first plate, the protrusion and pin defining a gap capable of accepting a cable.

Another aspect of this invention is a bracket comprising: a first plate having an inner face and an outer face; a second plate perpendicularly oriented with the first plate at one edge of the first plate; a pin located on the outer face of the first plate; and a protrusion associated with the first plate, the protrusion and pin defining a gap capable of accepting a cable.

Yet another aspect of this invention is a garage door assembly comprising: and overhead door having a plurality of horizontal panels including a top panel, a bottom panel and at least one intermediate panel whereas each panel has a first edge and a second edge; at least one cable attached to at least one of the horizontal panels; a bracket attached to an edge of one of the plurality of horizontal panels, the bracket including first plate having an inner face and an outer face, a pin located on the outer face of the first plate; and a protrusion associated with the first plate, the protrusion and pin defining a gap through which the garage door operator cable passes.

### DESCRIPTION OF THE FIGURES

FIGS. 1A, 1B and 1C are side, end and front views respectively of an embodiment of a cable brake bracket of this invention;

FIGS. 2A, 2B, 2C and 2D are side, end, front and perspective views of an embodiment of a cable bridge bracket of this invention;

FIGS. 3A, 3B and 3C are top, side and front views—from a position inside a garage, of a cable brake bracket embodiment of this invention that is associated with an overhead garage door;

FIG. 4 is a front view of an overhead door including multiple panels;

FIG. 5 is a side view of an overhead garage door assembly including a cable brake bracket embodiment of this invention wherein the overhead garage door is closed; and

FIGS. 6A, 6B and 6C are side views of different types of garage door openings including a cable brake bracket associated with at least one panel edge.

### DESCRIPTION OF A CURRENT EMBODIMENT

The present invention relates to overhead door cable brake brackets, to overhead garage door assemblies including cable brake bracket embodiment of this invention as well as to methods for opening and closing overhead doors that include cable brake bracket embodiments of this invention.

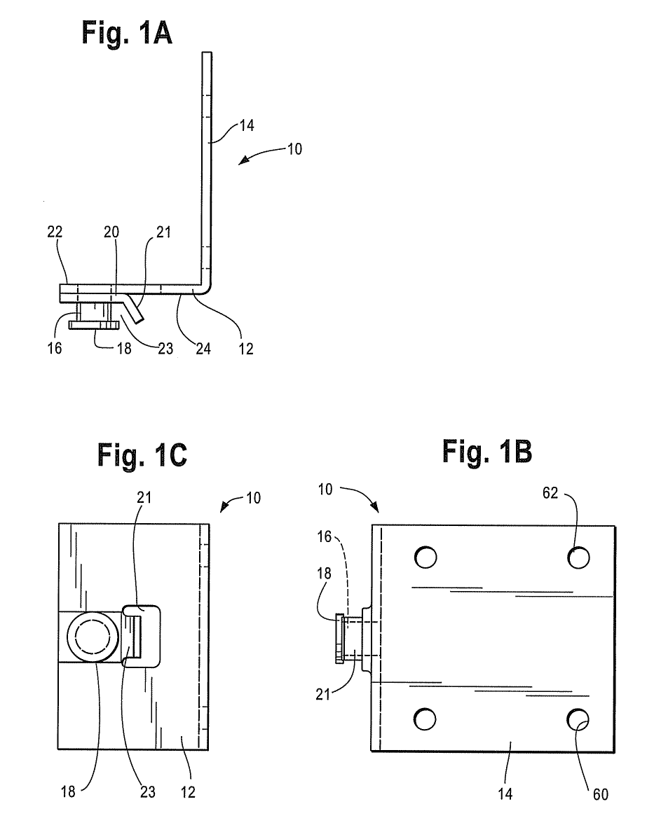

Referring now to the Figures, there is shown in FIGS. 1A, 1B and 1C an embodiment of a cable brake bracket of this invention. Cable brake bracket 10 includes a first plate 12 and a second plate 14. Bracket 10 further includes an inner face 22 and an outer face 24. A pin 16 is attached to outer face 24 of first plate 12. Pin 16 is preferably a solid rivet attached to first plate 12. Pin 16 has an optional cap 18. Cable brake bracket 10 also includes a protrusion 20. Protrusion 20 includes an outwardly angled arm 21 that in combination with either pin 16 and/or pin 16 and cap 18 forms a gap 23 with a width sufficient to accept a lifting cable. The term “accept a lifting cable” refers forming a gap 23 having a width that is equivalent to or slightly greater than the width of the lifting cable that would be located in gap 23. The term “accept a lifting cable” does require that lifting cable 50 must be located in gap 23 in a manner that prevents lifting cable 50 from escaping gap 23. However, in a preferred embodiment which will be discussed below, it is preferred that the combination of pin cap 18 and protrusion 20 forms a gap 23 which can also accept and retain lifting cable 50.

Several features of cable brake bracket 10 discussed above are optional. For example, second plate 14 is not a required bracket element, it is optional. Second plate 14 provides a second face against which bracket 10 can abut an edge of garage door panel 42.

It is preferred that bracket 10 includes a second plate 14 that is perpendicularly associated with one edge of first plate 12. Second plate 14 allows bracket 10 to be attached to the face of a garage door panel 42 instead just to an edge of the garage door panel and thereby strengthens the association of bracket 10 with garage door panel 42. Typically, garage door bracket 10 will include several apertures 60 through which screws or bolts 62 are directed to attach bracket 10 to garage door panel 42. Bracket 10 does not need to be attached to garage door panel 42 with screws or bolts. Any method for attaching a bracket to a garage door known to one skilled in the art can be used. Alternative methods for attaching bracket 10 to garage door panel 42 include but are not limited to welding and using an adhesive such as an epoxy resin.

Cap 18 of pin 16 is also optional so long as an adequate gap 23 can be formed between pin 16 and protrusion 20 to capture a garage door operator cable 50. However, it is preferred that pin 16 includes a cap 18 in order to securely retain cable 50 in gap 23. In a preferred embodiment, cap 18 merely needs to extend beyond the perimeter of pin 16 in the region of protrusion 20 in order to form a gap 23 to capture a garage door lifting cable. For ease of construction, it is preferred that cap 18 extends beyond the perimeter of pin 16 uniformly in all directions.

The shape of pin 16 and cap 18 is not critical. Pin 16 and cap 18 may be circular in shape, they can be oval, square or any other conceivable shape that performs the function of creating a gap 23 between protrusions 20 and pin 16 and/or cap 18. In a preferred embodiment, pin 16 is rounded in shape at least on the side of pin 16 that will be associated with cable 50. This minimizes the contrast between pin 16 and cable 50 thereby minimizing any friction created by the movement of cable 50 in gap 23.

Protrusion 20 as shown in FIG. 1A is a separate piece that is attached to outer face 24 of first plate 12. Moreover, pin 16 passes through protrusion 20 in a preferred embodiment shown in FIG. 1A. Alternatively, protrusion 20 may be integral to first plate 12 and be formed by punching out a portion of bracket first plate 12 to form the protrusion. Protrusion 20 can be formed by many other methods such as by attaching rods to first plate 12 and then bending them outwardly away from pin 16, by welding angled rods to first plate 12 or by any other means known by those skilled in the art of bracket manufacture. In FIGS. 1A, 1B, and 1C protrusion 20 has a width that is slightly greater than the width of cap 18.

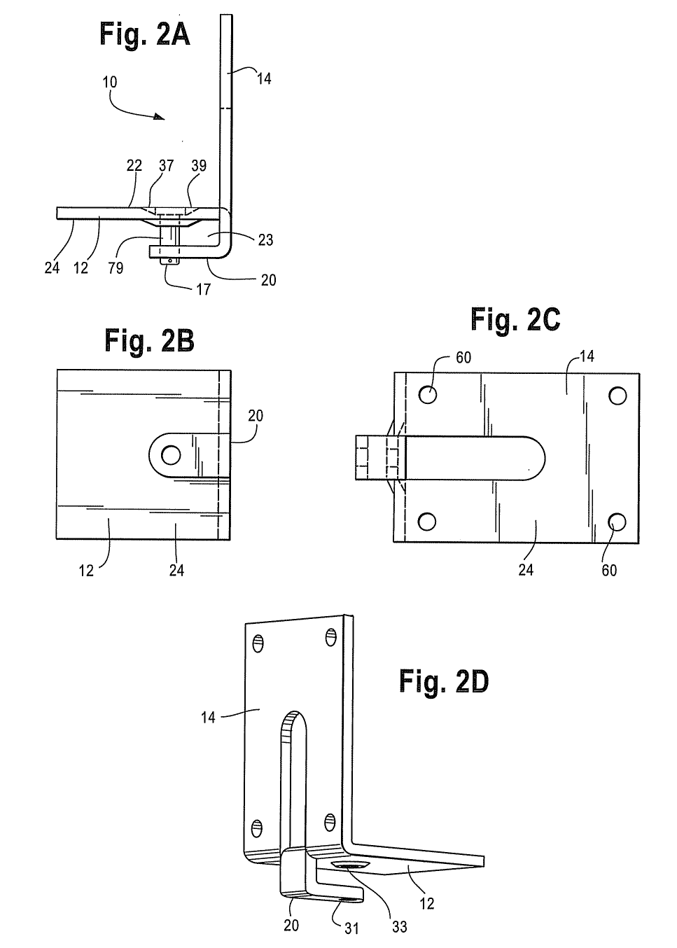

A second cable brake bracket embodiment of this invention is shown in FIGS. 2A-2D. The brackets shown in FIGS. 2A-2D are similar to the brackets shown in FIGS. 1A-1C in that they include a first plate 12 and a optional second plate 14. However, instead of having a cap 18 and pin 16, the bracket shown in FIGS. 2A-2D include an protrusion 20 including an aperture 77. First plate 12 also includes an aperture 78 that is complementary to aperture 77. A Milford pin 79 passes through apertures 77 and 78. Milford pin 79 is secured into place by passing a clevis pin or a cotter pin (not shown) through aperture 81 of pin 79. First plate 12 optionally includes a depression 37 that retains a head 39 of Milford pin 79. Depression 37 allows inner face 22 of first plate 12 to lay flush against the side of garage door panel after Milford pin 79 is inserted through apertures 77 and 78. The combination of Milford pin 79, extension 75 and first plate 12 forms a gap 23 through which a cable 50 associated with a garage door can pass and move freely.

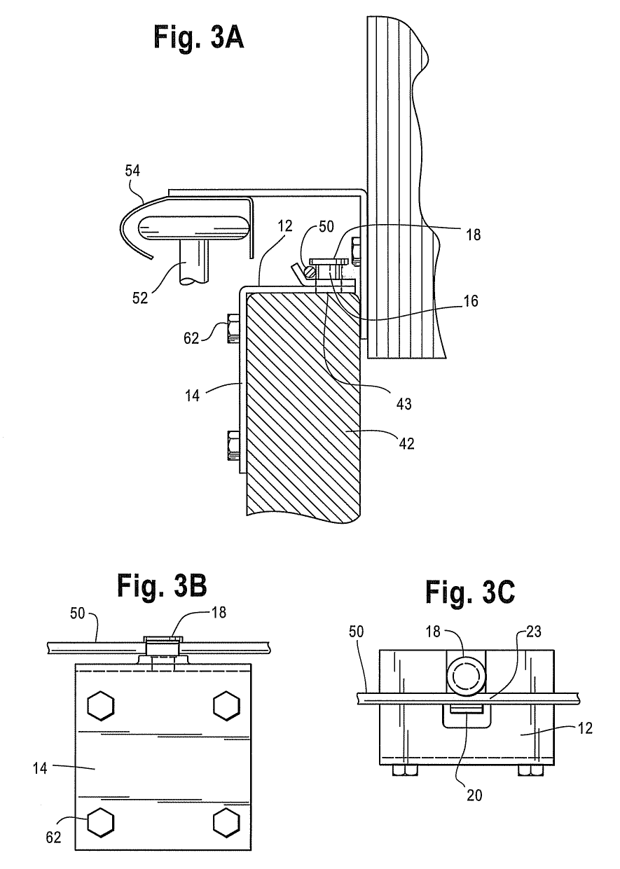

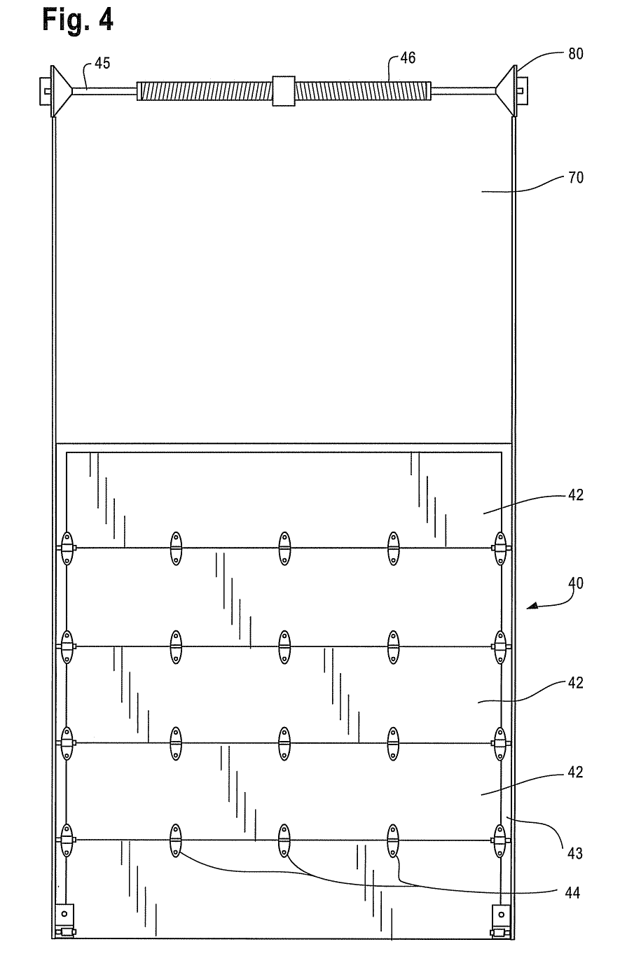

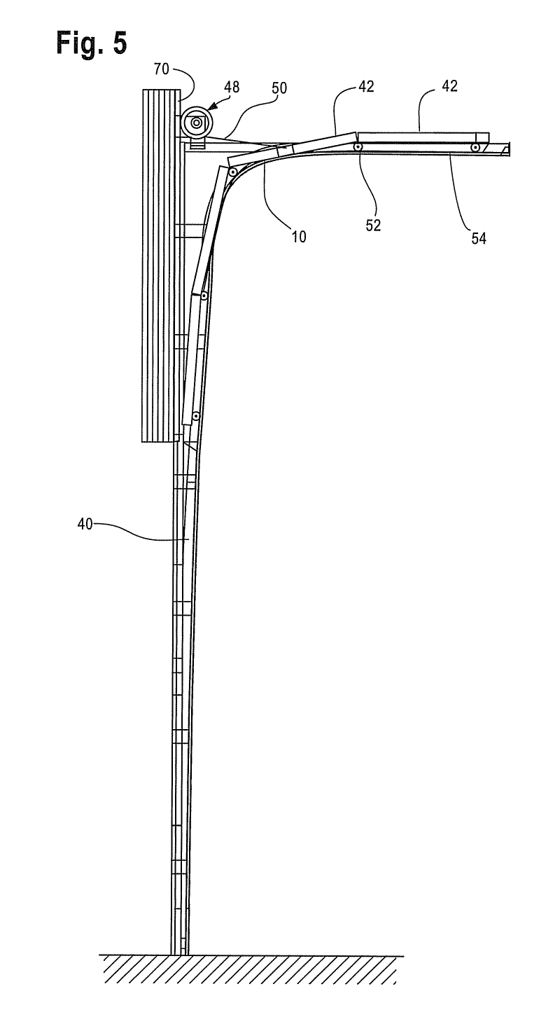

Cable brake bracket 10 of this invention is associated with a panel 42 of multi-panel garage door 40, as shown in FIGS. 3A, 3B, and 3C. Such a multi-panel garage doors are shown in FIGS. 4-5. Multi panel garage door 40 includes a plurality of panels 42, each panel having a height of from about 1 to about 4 feet or more and a width of from about 15 to about 40 feet or more. Multi panel garage door 40 will generally have a total height ranging from about 8 feet to about 20 feet or more depending upon the type of door.

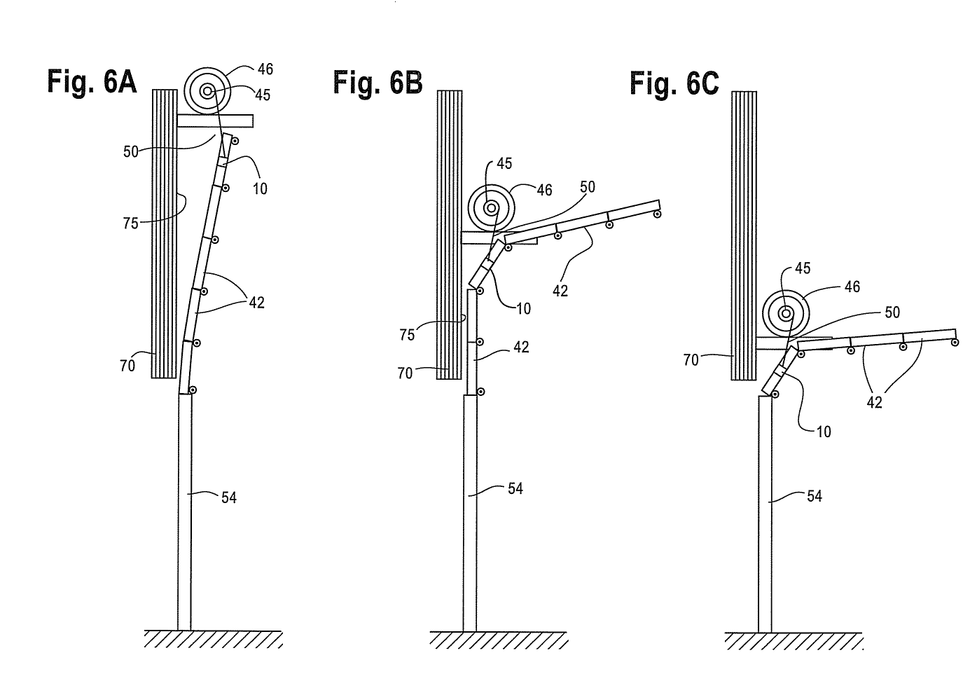

Three examples of garage door openings are shown in FIGS. 6A-6C. The garage door opening in FIG. 6C is what is known as a standard lift garage door. The garage door opening shown in FIG. 6B is known in the art as a high lift garage door. The garage door opening shown in FIG. 6A is known in the art as a vertical lift garage door. It should be noted that in FIGS. 6A-6C, the portion of garage door track 54 above header 70 is omitted in order to show the relationships between panels 42 and cable brake bracket 10. In the standard lift garage door shown in FIG. 6C, tube shaft or solid shaft 45 surrounded by a spring 46 is associated with header 70 immediately above the garage door opening. The garage door track 54 is constructed such that the garage door turns at about a 90 degree angle at header 70.

The high lift door shown on FIG. 6B includes a tube shaft or solid shaft 45 including a spring 46 located at a distance that is located significantly above the garage door lintel 75. Likewise, the track 54 directs the garage door panels vertically above the opening and then causes the panels to move essentially perpendicular to the opening once the panels reach the tubular shaft and spring.

In the vertical lift door shown in FIG. 6A, the tubular shaft or solid shaft 45 and associated spring 46 are again located well above the garage door lentil 75. With the vertical lift door, the garage door panels never move perpendicular or essentially perpendicular to the garage door opening. Instead, the panels are directed by track 54 in a vertical or near vertical direction away from the garage floor.

The panel(s) 42 to which the cable brake bracket(s) of this invention are attached will vary depending on the type of garage door being used. With a vertical lift door shown in FIG. 6A, the cable brake bracket(s) will be attached to the top most panel of the garage door. In the standard lift door shown in FIG. 6C, the cable brake bracket(s) will be attached to the bottom most panel, i.e. the panel closest to the floor when the garage door is closed. Finally, with the high lift door shown in FIG. 6B, the cable brake bracket 10 will preferably be associated with a panel located at a distance from the top of the panel garage door that is equal to about the distance between the center lines of the shaft to the bottom of the lentil.

A typical garage door will include a plurality of panels 42. Each panel 42 includes edges 43. Moreover, adjacent panels 42 are typically associated with one another by a plurality of laterally spaced hinges 44 that span gaps between adjacent panels 42 and that allow adjacent panels to be oriented at an angle with respect to one another. Rollers 52 are associated with the panel edges 43. Rollers 52 will typically have one end that is a roller and a second end that is a screw or threaded connection. The second end passes into the edge of garage door panel 42 to secure roller 52 to the panel edge 43. Rollers 52 are located in a track 54 which lies outside of the periphery of the multi panel garage door 40. Track 54 directs the travel of the multi panel garage door 40 when it is opened and closed.

A tubular or solid shaft 45 including a spring 46 is associated with header 70 above the garage door opening. A pulley 48 is attached to at least one end of shaft 45. Preferably a pulley 48 is attached at each end of shaft 45. A cable 50 passes over pulley 48 and is attached at a first end to at least one edge of a panel 42 of the multi panel garage door 40. A second end of cable 50 is fixedly attached to pulley 48. A drum 80 including a chain is also associated at at least one end of shaft 45. Chain 82 will typically engage a gear in drive in drum 80. Pulling chain 82 rotates the gear drum and also pulley 48. Rotation of pulley 48 causes cable 50 to wind or unwind from pulley 48. Thus, by attaching a first end 52 of cable 50 a garage door panel and a second end of cable 50 to pulley 48, the rotation of pulley 48 causes the multi panel garage door to open or close.

A cable brake bracket 10 is associated with at least one edge 43 of a panel 42 of multi-panel garage door 40. More preferably, two cables brake brackets 10 will be associated with opposing edges 43 of the same garage door panel 42 as shown in FIGS. 6A-6C. Moreover, when two cable brake brackets are used, the cable brake brackets will each be located on opposing edges of the same panel 42 at essentially the same distance from the bottom of the first garage door panel.

FIGS. 3A-3C show a cable brake bracket 10 associated with a panel 42 of a multi panel garage door 40. As shown in FIGS. 3B and 3C, cable 50 is located in gap 23 defined by the space between pin 16 and protrusion 20 of cable brake bracket 10.

FIGS. 4-5 show a multi panel overhead garage door 40 in a closed position. In FIG. 5, cable 50 runs down the edge of the plurality of panels 42 associated with multi panel garage door 40. As the bottom of the door reaches its desired opening height, the panel 42′ that includes cable brake bracket 10 moves from a vertical to an essentially horizontal position along track 54. As panel 42′ moves into a horizontal position, cable 50 becomes essentially locked between cap 18 and protrusion 20 thereby gently stopping the opening movement of multi panel garage door 40. In order to close multi panel garage door 40, the movement of cable 50 is reversed and cable 50 becomes unlocked from cable brake bracket 10 thereby allowing the multi panel garage door to close by virtue of its own weight.

What is claimed is:

1. A bracket comprising:
a first plate having an inner face and an outer face;
a pin located on the outer face of the first plate; and
a protrusion associated with the first plate, the protrusion and pin defining a gap capable of accepting a cable.

2. The bracket of claim 1 wherein the pin has cap and wherein the pin cap and the protrusion define a gap capable of accepting a cable.

3. The bracket of claim 2 wherein the pin includes a perimeter and wherein the cap extends beyond the pin perimeter at least in the region where the cap and the protrusion form the gap.

4. The bracket of claim 3 wherein the cap extends beyond the entire pin perimeter.

5. The bracket of claim 1 including a second plate wherein the second plate is essentially perpendicular to the first plate.

6. The bracket of claim 5 wherein the first plate is integral to the second plate.

7. The bracket of claim 1 wherein the protrusion is outwardly angled away from the pin.

8. The bracket of claim 1 wherein the protrusion is punched out of the first plate.

9. The bracket of claim 1 wherein the protrusion is attached to the outer face of the first plate.

10. The bracket of claim 1 wherein the protrusion is elongated.

11. The bracket of claim 1 wherein the pin is Milford pin.

12. The bracket of claim 11 wherein the Milford pin includes a head and wherein first plate inner face includes a depression that is complementary to the Milford pin head.

13. A bracket comprising:
a first plate having an inner face and an outer face;
a second plate perpendicularly oriented with the first plate;
a pin located on the outer face of the first plate; and
a protrusion associated with the first plate, the protrusion and pin defining a gap capable of accepting a cable.

14. A garage door assembly comprising:
and overhead door having a plurality of horizontal panels including a top panel, a bottom panel and at least one intermediate panel wherein each panel includes a first edge and a second edge;
a horizontal shaft having a first end and a second end, and at least one pulley associated with an end of the shaft, the shaft surrounded by a spring;
at least one chain drive associated with the horizontal shaft for rotating the shaft while the spring remains stationary;
at least one bracket attached to an edge of one of the plurality of horizontal panels, the bracket including first plate having an inner face and an outer face, a pin located on the outer face of the first plate; and a protrusion associated with the first plate, the protrusion and pin defining a gap; and
a cable having a first end attached to a garage door panel and a second end attached to the at least one pulley.

15. The garage door assembly of claim 14 including two pulleys located at opposite ends of the shaft and two brackets wherein a first bracket is attached to a first edge of an overhead door panel and the second bracket is attached to the second edge of the overhead door panel wherein a second cable is attached at one end to the second pulley.
